(19) United States
(12) Patent Application Publication
(10) Pub. No.: US 2008/0080712 A1
(43) Pub. Date: Apr. 3, 2008

(54) System and methods for secure communication using an enhanced GPS receiver

(76) Inventors: Haiquan Huang, Shengdu (CN); Cheng Li, Shengdu (CN); Huafeng Qian, Shengdu (CN)

Correspondence Address: Wang Law Firm, Inc., 4989 Peachtree Parkway,, Suite 200, Norcross, GA, 30092, US

(21) Appl. No.: 11/541,470

(22) Filed: Sep. 29, 2006

(51) Int. Cl. H04K 1/00

(52) U.S. Cl. 380/258

(57) ABSTRACT

An enhanced GPS receiver is provided for secure location information communication. The GPS receiver includes a GPS signal receiving unit, a GPS signal processing unit, and en encryption module. The GPS signal receiving unit is used to receive the GPS signals. The GPS signal processing unit coupled to the GPS receiving unit is used to obtain the location information of the mobile device. The encryption module encrypts the location information by using a GPS chip identification number embedded in the GPS receiver as an encryption key. The GPS receiver further optionally includes a compression module for compressing the location information before encryption.

### FIELD OF THE INVENTION

The invention relates to secure data communication, and more particularly, to secure location-based data communication using an enhanced GPS receiver.

### BACKGROUND OF THE INVENTION

With the advent of the Global Positioning System (GPS), there is a growing demand for mobile devices that can locate and track objects or people, such as children, elders, tourists, valuable assets, and the like. Most commonly, GPS receivers are used in the mobile devices. The GPS receiver is capable of receiving GPS signals from GPS satellites and determining the location of the mobile device based on the received GPS signals. The location information may be transmitted by a transmitting unit coupled to the GPS receiver in the mobile device to a terminal such as a monitoring terminal, or a control center. As a result, the monitoring terminal or the control center is able to provide a corresponding response or instruction according to the received location information to the object or people carrying the mobile device or inside the mobile device, such as, a car, a cell phone, etc.

One example of the usage of the GPS receiver is tracking of children by their parents when children are carrying cell phones equipped with a GPS receiver. The GPS receiver is used to determine the location of the child. Location information of the child will thus be transmitted through the cell phone over a wireless network by means of Short Message Service (SMS). At parent side, he or she also has a cell phone capable of receiving the location information related SMS messages. Consequently, parents are able to monitor and track the location of their children.

Another example of the usage of the GPS receiver is a vehicle control system. A vehicle control center needs to collect location information of fleets, such as taxicabs, delivery trucks, etc. to make sure that all the vehicles are within a predetermined geographical boundary. In addition, upon these collected location information, the control center may be able to give dispatch assignment to the fleets. Each vehicle in the fleet is usually equipped with a GPS receiver for obtaining location information. Such location information is transmitted to the control center by a transmitting device in each vehicle. After the control center receives the location information, it analyzes the location information and sends out instructions to the associated vehicle to control their routes.

However, there are several problems with the conventional communication approaches for transmitting the GPS location information. Since the location information is transmitted over the air, it is susceptible to unwanted tampering or interception. Without any identification process or encryption process, the location information can be easily received by other people, thereby causing security issues. Furthermore, GPS location spoofing may occur if the receiving side does not require identification of the sender of the data. In solving the problem, some mobile devices on the market provide an encryption feature. When equipped with GPS receivers, these mobile devices may be able to encrypt the location information received from the GPS receiver and send the encrypted location information to the intended receiver, and thus enhancing the security of data communication. However, the problem with this approach is that the encryption module is integrated in the mobile device. The GPS receiver itself does not include the encryption module. When this GPS receiver is installed on another mobile device, unless the mobile device also provides an encryption module, the GPS location information in transmission is open to public since no encryption is performed. However, if the encryption module is integrated in the GPS receiver instead of the mobile device, no matter what mobile device it is attached to, location information can be encrypted given the fact that the encryption feature are integrated in the GPS receiver.

Therefore, it is to an enhanced GPS receiver that is able to provide encryption feature for the purpose of a secure data communication with flexible application that the present invention is primarily directed.

### SUMMARY OF THE INVENTION

The present invention advantageously provides a method and system for a secure location information transmission in a wireless communication network using an enhanced GPS receiver. As a result, a secure location information communication with flexible application can be achieved.

In one embodiment, a method for communicating data between a mobile device and a terminal is provided. The method includes obtaining location information from a GPS receiver in the mobile device, wherein the location information is representative of a location of the mobile device. The method further includes obtaining a GPS chip identification number from the GPS receiver, using the GPS chip identification number as an encryption key to encrypt the location information at the GPS receiver, generating an encrypted location information, transmitting the encrypted location information at the mobile device, receiving the encrypted location information at the terminal, using the GPS chip identification number as a decryption key to decrypt the encrypted location information at the terminal, and obtaining the location information at the terminal.

In yet another embodiment, an enhanced GPS receiver is provided. The GPS receiver has a unique GPS chip identification number for identifying the GPS receiver. The GPS receiver includes a GPS signal receiving unit, a GPS signal processing unit, and an encryption module. The GSP signal receiving unit is used to receive GPS signals from GPS satellites. The GPS signal processing unit is coupled to the GPS signal receiving unit and is used to process the GPS signals and obtain location information of the GPS receiver. The encryption module is used to encrypt the location information by using the GPS chip identification number as an encryption key and generate an encrypted location information.

In yet another embodiment, a mobile device is provided. The mobile device includes a GPS receiver, a transmitting unit and a display unit. The GPS receiver has a unique GPS chip identification number. The GPS receiver includes a GPS signal receiving unit, a GPS signal processing unit, and an encryption module. The GPS signal receiving unit receives GPS signals from GPS satellites. The GPS signal processing unit is coupled to the GPS signal receiving unit and is used to process the GPS signals and obtain location information of the GPS receiver from the GPS signals. The encryption module is used to encrypt the location information by using the GPS chip identification number as an encryption key and generate an encrypted location information. The transmitting unit is coupled to the GPS receiver and is used to transmit the encrypted location information over a wireless network. The displaying unit is coupled to the GPS receiver and is used to display the location information.

In yet another embodiment, a location monitoring system is provided. The location monitoring system includes a mobile device and a terminal for monitoring the mobile device. The mobile device includes a GPS receiver having a unique GPS chip identification number and a first transmitting unit coupled to the GPS receiver. The GPS receiver includes a GPS signal receiving unit for receiving GPS signals from GPS satellites, a GPS signal processing unit coupled to the GPS signal receiving unit for processing the GPS signals and obtaining location information of the GPS receiver, and an encryption module for encrypting the location information to generate an encrypted location information by using the GPS chip identification number as an encryption key. The first transmitting unit is used to transmit the encrypted location information over a wireless network. The terminal includes a first receiving unit for receiving the encrypted location information, and a first decryption module coupled to the first receiving unit for decrypting the encrypted location information by using the GPS chip identification number as a decryption key.

### BRIEF DESCRIPTION OF THE DRAWINGS

Features and advantages of embodiments of the invention will become apparent as the following Detailed Description proceeds, and upon reference to the Drawings, where like numerals depict like elements, and in which:

FIG. 1 is architecture of a location monitoring system;

FIG. 2 depicts details of the architecture of location monitoring system shown in FIG. 1 according to one embodiment of the present invention;

FIG. 3 is an exemplary code structure for a GPS chip identification number;

FIG. 4 is an exemplary data format for a communication protocol according to one embodiment of the present invention; and

FIG. 5 is a flowchart for secure location information communication according to one embodiment of the present invention.

### DETAILED DESCRIPTION OF THE INVENTION

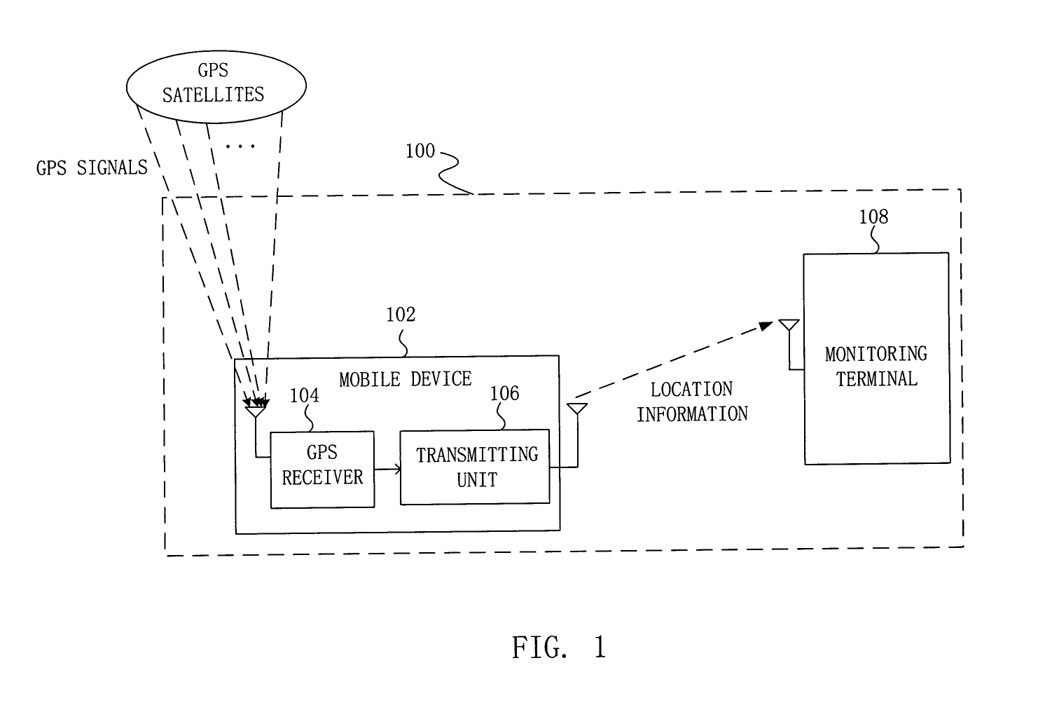

FIG. 1 illustrates architecture of a location monitoring system 100 according to one embodiment of the invention. The system 100 includes a mobile device 102 and a monitoring terminal 108 (also known as a terminal, or control center). The mobile device 102 can be a car, a personal digital assistant or a cell phone, etc. In operation, the monitoring terminal 108 monitors the mobile device 102 by receiving location information transmitted from the mobile device 102. Upon receiving the location information, the monitoring terminal 108 may be capable of sending out response signal or control signal to the mobile device 102 for further action.

The mobile device 102 at least includes a GPS receiver 104 and a transmitting unit 106 coupled to the GPS receiver 104. The GPS receiver 104 acquires GPS signals transmitted from a plurality of GPS satellites. After acquiring the GPS signals, the GPS receiver 104 further keeps track of the GPS signals, processes the GPS signals, and generates the location information indicating the present location of the mobile device 102. The transmitting unit 106 in the mobile device transmits the location information received by the GPS receiver to a monitoring terminal over a wireless network. The wireless network includes, but not limited to, a GSM (Global System for Mobil Communications) network, GPRS (General Packet Radio Service) network, and CDMA (Code Division Multiple Access) network, etc. The monitoring terminal 108 receives the location information of the mobile device 102 and may further be capable of sending out commands (not shown in FIG. 1) to the mobile device 102 over the wireless network based on the received location information. The location information can be transmitted by means of a SMS (Short Message Service) module or through a serial port of the mobile device. In some embodiments, the mobile device 102 may further includes a display unit for displaying the location information.

It is understood by those skilled in the art that the mobile device 102 may further includes a receiving unit (not shown in FIG. 1) to receive the commands or response from the monitoring terminal 108. It should be further noted that the location monitoring system 100 may support a plurality of mobile device. All of the mobile devices may transmit their corresponding location information to the monitoring terminal 108. Accordingly, traces of the plurality of mobile devices may well be monitored by the monitoring terminal. Furthermore, it is readily appreciated by those skilled in the art that the monitoring terminal may also be in a form of another mobile device having a GPS receiver, a transmitting unit for transmitting response message or the location information indicating the location of itself to the mobile device 102 and a receiving unit for receiving the location information from the mobile device 102.

Advantageously, the GPS receiver 104 is an enhanced receiver according to one embodiment of the present invention. It provides at least an encryption module to encrypt the location information using a GPS chip identification number as a key. The following description is a detailed explanation of an implementation of this embodiment of the present invention.

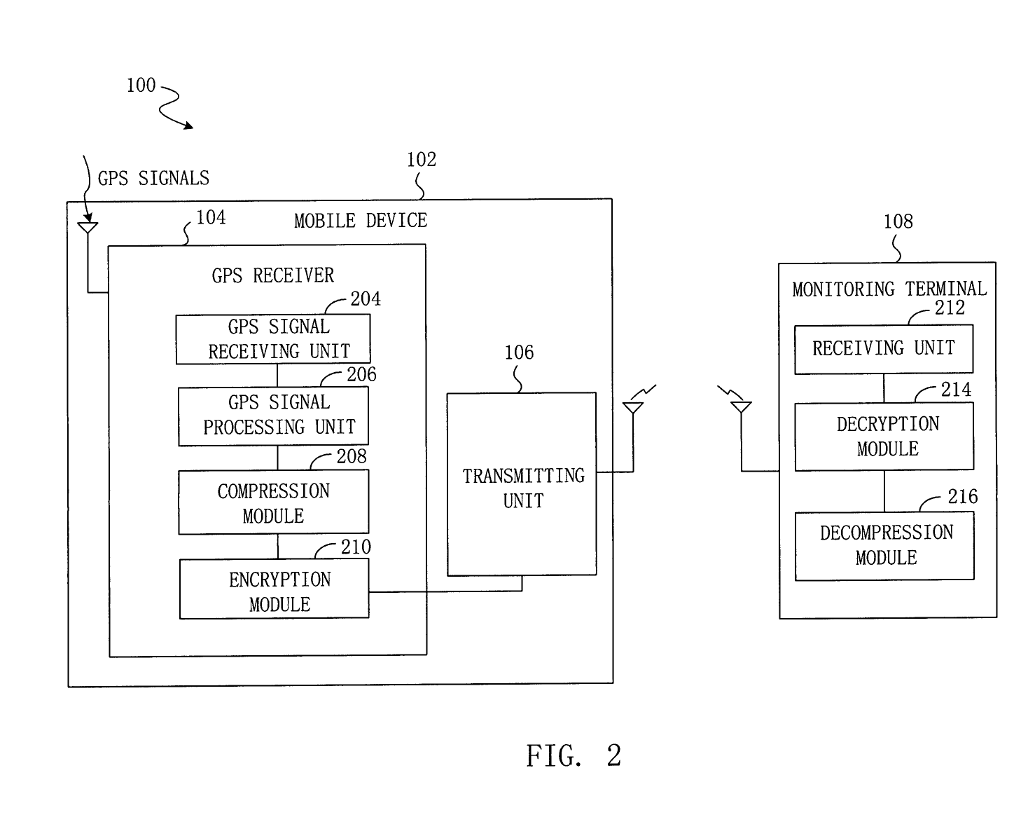

FIG. 2 illustrates a detailed block diagram of system 100. The GPS receiver 104 includes a GPS signal receiving unit 204, a GPS signal processing unit 206, an optional compression module 208, and an encryption module 210. The GPS signal receiving unit 204 receives the GPS signal and converts the frequency of the GPS signal to an intermediate frequency level. The receiving unit 204 can be a RF front end module which is known by those skilled in the art. A GPS signal processing unit 206 coupled to the GPs signal receiving unit 204 is used to further process the GPS signal. The processing unit 206 may include a plurality of modules, such as an acquisition module, a tracking module, and a post-processing module, known by those skilled in the art. Based on the received GPS signal, the processing unit 206 may output location information representative of the user's current location or the location of the mobile device 102.

Usually, the signal processing unit 204 and GPS signal receiving unit 206 are integrated in a GPS chip. The GPS chip has a unique number provided by a GPS vendor and is stored permanently in a FLASH memory of the GPS chip. This number can be requested by the user from the GPS receiver system. This unique number is referred to as a GPS chip identification number herein.

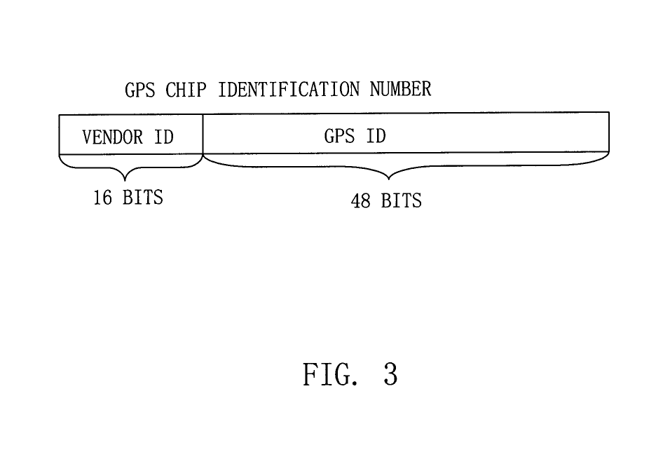

FIG. 3 illustrates a code structure of the GPS chip identification number. In one embodiment, this GPS identification number can be a digital number having a data length of 64-bits. The number includes two parts. The high 16-bits represents vendor ID, and the low 48-bits is used to identify each GPS chip. Consequently, the GPS chip identification number can uniquely identify each GPS chip manufactured by each GPS vendor. Advantageously, the present invention utilizes the GPS chip identification number as an encryption key to encrypt the location information in an encryption module 210 of the GPS receiver. Only the authorized receiving terminals know the GPS chip identification number. These receiving terminals may use this identification number as a decryption code to decrypt the location information. Therefore, by using the GPS chip identification number as an encryption or decryption key, the location information can be kept confidential before it is received and decrypted by the intended receiving terminals. Consequently, a secure data communication can be realized. In this case, the monitoring terminal has the GPS chip identification numbers of all the mobile devices in advance. Therefore, it may be able to receive the location information from each mobile device safely.

There are two ways to obtain the GPS chip identification number. A GPS software may be used to obtain the GPS chip identification number from the GPS chip when the GPS system is initially booted. Alternatively, a GPS user may assign a pre-defined unique identification number and upload it to GPS system as the GPS chip identification number.

Turning back to FIG. 2, for the purpose of delivering a large throughput of the transmission data, the present invention optionally provides a compression module 208 before the encryption module 210. The compression module 208 receives the location information from the signal processing unit 206, compresses the location information and delivers the compressed location information to the encryption module 210. In one embodiment, the compression algorithm can be LMZA (Lempel and Ziv Modified Compression Algorithm). LZMA provides high compression ratio and very fast decompression, so it is very suitable for embedded applications. Of course, it should be noted that the compression can also be performed after encryption, while, at the receiving terminal, the decompression can be performed before decryption. However, the data length will be longer compared with the method described in FIG. 2.

The encryption module 210 receives the compression location information and encrypts the location information using the GPS chip identification number as an encryption key, and sends the encrypted location information to the transmitting unit 106. In one embodiment, the user may selectively choose to enable the encryption feature or disable the encryption feature. A symmetric encryption algorithm is preferred in a wireless network application. The symmetric encryption algorithm includes, but not limited to, DES (Data Encryption Standard) algorithm and MD5 algorithm (Message-Digest Algorithm version.5), etc. In addition, in order to have a more secure data communication environment, WPKI (Wireless Public Key Infrastructure) can be utilized. The WPKI is commonly used in wireless business transaction application. Advantageously, the present invention adopts this algorithm in GPS fields for a high level security request.

The monitoring terminal 108 includes a receiving unit 212, a decryption module 214, and an optional decompression module 216. The receiving unit 212 receives the encrypted location information transmitted from the mobile device 102. The decryption module 214 receives the encrypted location information, and decrypts the location information using the GPS chip identification number as a decryption key. The decompression module 216 is capable of decompressing the output of decryption module 214 if the location information is compressed before transmission. After the data is decompressed, the location information is obtained.

In yet another embodiment, the monitoring terminal 108 may not only be able to receive the location information from the mobile device 102, but may also be able to send out messages, commands, or location information. In this case, the monitoring terminal may further include a transmitting unit, an optional compression module, and an optional encryption module if the commands, messages or location information need to be protected. In this case, the mobile device 102 may further include a receiving unit for receiving the commands, messages, or location information from the monitoring terminal 108. The GPS receiver 104 may further include an optional decryption module coupled to the receiving unit for decrypting the data from the monitoring terminal, and an optional decompression module for decompressing the data from the monitoring terminal accordingly.

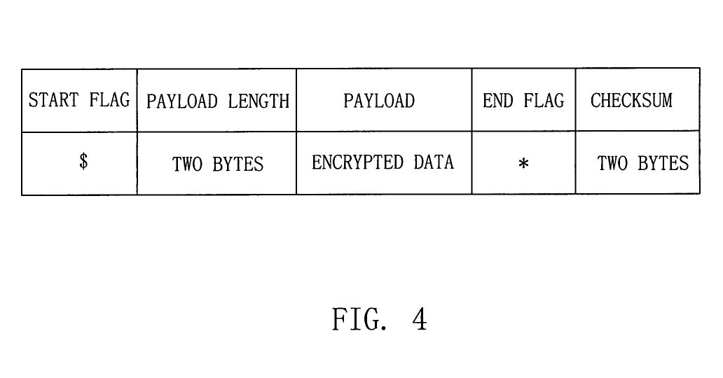

As previously stated, the data is transmitted through serial port or SMS module. The data is exchanged according to a communication protocol. FIG. 4 is the communication protocol illustrating the format of the data in transmission according to one embodiment of the present invention. The data format includes several segments: a start flag, a payload length segment, a payload segment, an end flag and a checksum segment. The start flag is a one-bit symbol representing the start of a message. The payload length is a two-byte data indicating the length of the data. The payload segment contains the data, which may be encrypted. The end flag is a one-bit symbol representing the end of a message. The checksum segment is a two-byte data for data verification purpose. The payload length, payload and checksum data segment are transmitted with high order byte first followed by the low order byte.

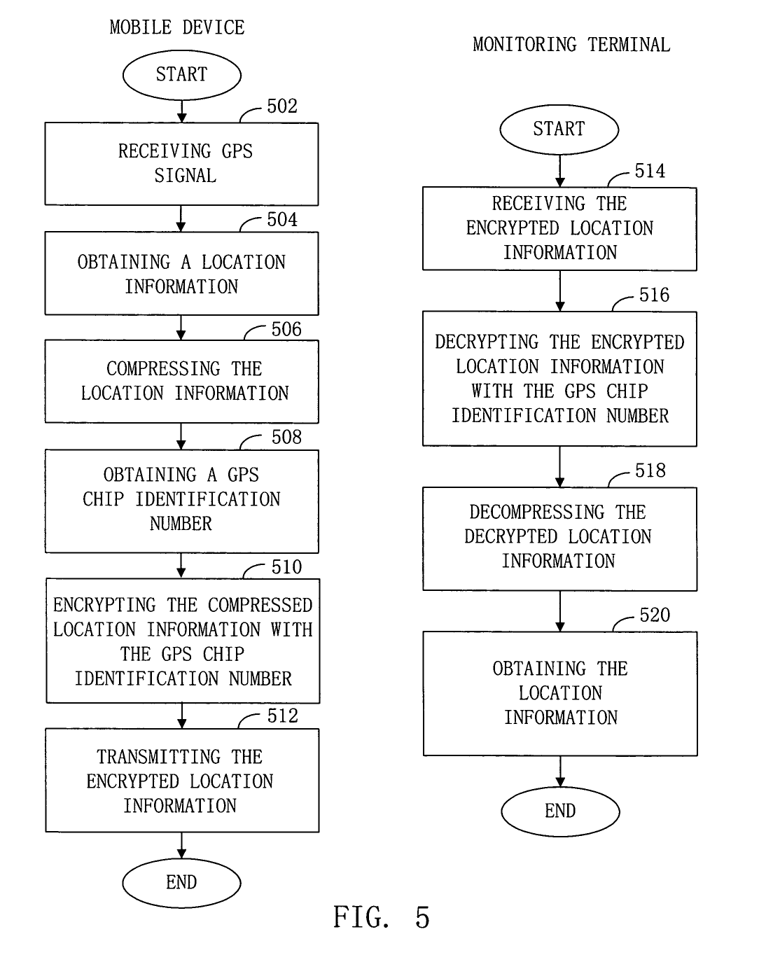

FIG. 5 illustrates a flowchart for secure location information communication according to one embodiment of the present invention. At the mobile device side, the GPS receiver receives the GPS signal from GPS satellites, step 502, and obtains the location information of the mobile device, step 504. After obtaining the location information, the location information can be optionally compressed in a compression module in the GPS receiver, step 506. In order to encrypt the location information, a GPS chip identification number is obtained, step 508. Then, the encryption module encrypts the location information with the GPS chip identification number, step 510. A transmitting unit coupled to the encryption module transmits the encrypted location information over a wireless network, step 512. At the receiving terminal (monitoring terminal), a receiving unit in the receiving terminal receives the encrypted location information, step 514. Then, a decryption module decrypts the encrypted location information with the same GPS chip identification number, step 516. If the location information is compressed before transmission, a decompression module in the receiving terminal will be used to decompress the compressed location information, step 518. After compression, the location information can be obtained, step 520.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

What is claimed is:

1. A method for communicating location information between a mobile device and a remote terminal, said mobile device having a Global Positioning System (GPS) receiver, comprising:
obtaining location information from said GPS receiver, said location information representing a location of said mobile device;
obtaining a GPS chip identification number from said GPS receiver;
using said GPS chip identification number as an encryption key to encrypt said location information into an encrypted location information at said GPS receiver;
transmitting said encrypted location information to said remote terminal.

2. The method of claim 1, further comprising:
receiving said encrypted location information at said terminal;
using said GPS chip identification number as a decryption key to decrypt said encrypted location information at said terminal; and
obtaining said location information at said terminal.

3. The method of claim 1, further comprising:
compressing said location information before encrypting said location information;

4. The method of claim 1, wherein said GPS receiver having a GPS chip, said GPS chip having said GPS chip identification number, said GPS chip identification number uniquely identifying every GPS chip.

5. The method of claim 4, wherein obtaining said GPS chip identification number comprising providing a unique identification number of said GPS chip as said GPS chip identification number, said unique identification number being initially provided by a GPS chip vendor.

6. The method of claim 4, wherein obtaining said GPS chip identification number comprising providing a user-defined identification number as said GPS chip identification number.

7. The method of claim 1, wherein the encrypting is performed based on Data Encryption Standard (DES) encryption algorithm.

8. The method of claim 1, wherein the encrypting is performed based on Wireless Public Key Infrastructure (WPKI) encryption system.

9. The method of claim 1, wherein the encrypting is performed based on Message-Digest Algorithm 5 (MD5) encryption algorithm.

10. A Global Positioning System (GPS) receiver having a GPS chip identification number, comprising:
a GPS signal receiving unit for receiving GPS signals from GPS satellites;
a GPS signal processing unit coupled to said GPS signal receiving unit for processing said GPS signals and obtaining location information of said GPS receiver; and
an encryption module for encrypting said location information by using said GPS chip identification number as an encryption key and generating an encrypted location information.

11. The receiver of claim 10, wherein said receiver being further coupled to a transmitting unit, said transmitting unit being capable of receiving said encrypted location information and transmitting said encrypted location information to a terminal over a wireless network.

12. The receiver of claim 11, wherein said encrypted location information is transmitted over said wireless network by means of Short Message Service (SMS).

13. The receiver of claim 10, wherein said GPS receiver having a GPS chip, said GPS chip having said GPS chip identification number, said GPS chip identification number uniquely identifying each GPS chip.

14. The receiver of claim 13, wherein said GPS ID identification number being a unique identification number provided by a GPS vendor.

15. The receiver of claim 13, wherein said GPS ID identification number is a use-defined identification number.

16. The receiver of claim 10, wherein said encryption module is performed based on Data Encryption Standard (DES) encryption algorithm.

17. The receiver of claim 10, wherein said encryption module is performed based on Wireless Public Key Infrastructure (WPKI) encryption system.

18. The receiver of claim 10, wherein said encryption module is performed based on Message-Digest Algorithm 5 (MD5) encryption algorithm.

19. The receiver of claim 10, further comprising:
a compression module coupled to said GPS signal processing unit for compressing said location information, obtaining a compressed location information, and sending said compressed location information to said encryption module.

20. A mobile device capable of receiving GPS signals and calculating location information based on said received GPS signals, comprising:
a GPS receiver having a GPS chip identification number, said GPS receiver further comprises:
a GPS signal receiving unit for receiving GPS signals from GPS satellites;
a GPS signal processing unit coupled to said GPS signal receiving unit for processing said GPS signals and obtaining location information of said GPS receiver from said GPS signals; and
an encryption module for encrypting said location information by using said GPS chip identification number as an encryption key and generating an encrypted location information;
a transmitting unit coupled to said GPS receiver for transmitting said encrypted location information over a wireless network; and
a display unit coupled to said GPS receiver for displaying said location information.

21. The mobile device of claim 20, wherein said encrypted location information is transmitted over said wireless network by means of Short Message Service (SMS).

22. The mobile device of claim 20, wherein said GPS receiver having a GPS chip, said GPS chip having said GPS chip identification number, said GPS chip identification number uniquely identifying each GPS chip.

23. The mobile device of claim 20, wherein said encryption module is performed based on Data Encryption Standard (DES) encryption algorithm.

24. The mobile device of claim 20, wherein said encryption module is performed based on Wireless Public Key Infrastructure (WPKI) encryption system.

25. The mobile device of claim 20, wherein said encryption module is performed based on Message-Digest Algorithm 5 (MD5) encryption algorithm.

26. The mobile device of claim 20, wherein said GPS receiver further comprising a compression module coupled to said GPS signal processing unit for compressing said location information, obtaining a compressed location information, and sending said compressed location information to said encryption module.

27. A location monitoring system, comprising:
a mobile device comprising:
a Global Positioning System (GPS) receiver having a GPS chip identification number, said GPS receiver further having a GPS signal receiving unit for receiving GPS signals from GPS satellites, a GPS signal processing unit coupled to said GPS signal receiving unit for processing said GPS signals and obtaining location information of said GPS receiver, and an encryption module for encrypting said location information to generate an encrypted location information by using said GPS chip identification number as an encryption key; and
a first transmitting unit coupled to said GPS receiver for transmitting said encrypted location information over a wireless network; and
a terminal for monitoring said mobile device, comprising:
a first receiving unit for receiving said encrypted location information; and
a first decryption module coupled to said first receiving unit for decrypting said encrypted location information by using said GPS chip identification number as a decryption key.

28. The location monitoring system of claim 27, wherein said encrypted location information is transmitted over said wireless network by means of Short Message Service (SMS).

29. The location monitoring system of claim 27, wherein said GPS receiver having a GPS chip, said GPS chip having said GPS chip identification number, said GPS chip identification number uniquely identifying each GPS chip.

30. The location monitoring system of claim 27, wherein said encryption module is based on Data Encryption Standard (DES) encryption algorithm.

31. The location monitoring system of claim 27, wherein said encryption module is based on Wireless Public Key Infrastructure (WPKI) encryption system.

32. The location monitoring system of claim 27, wherein said encryption module is based on Message-Digest Algorithm 5 (MD5) encryption algorithm.

33. The location monitoring system of claim 27, wherein said GPS receiver further comprising a first compression module coupled to said GPS signal processing unit for compressing said location information, obtaining a compressed location information, and sending said compressed location information to said encryption module.

34. The location monitoring system of claim 33, wherein said terminal further comprising a first decompression module coupled to said first decryption module for decompressing said compressed location information after said encrypted location information is decrypted.

35. The location monitoring system of claim 27, wherein said mobile device further comprising a second receiving unit for receiving a terminal data from said terminal.

36. The location monitoring system of claim 35, wherein said GPS receiver further comprising a second decryption module coupled to said second receiving unit for decrypting said terminal data by using a terminal identification number as a decryption key provided by said terminal if said terminal data is encrypted with said terminal identification number.

37. The location monitoring system of claim 35, wherein said GPS receiver further comprising a second decompression module for decompressing said terminal data if said terminal data is compressed.
